(19) United States
(12) Patent Application Publication
(10) Pub. No.: US 2008/0278745 A1
(43) Pub. Date: Nov. 13, 2008

(54) Multiple output devices with rules-based sub-job device selection

(75) Inventors: Javier A. Morales, Irondequoit, NY (US); Heidi O. Thatcher, Webster, NY (US)

Correspondence Address: ORTIZ & LOPEZ, PLLC, P. O. BOX 4484, ALBUQUERQUE, NM, 87196-4484, US

(73) Assignee: Xerox Corporation

(21) Appl. No.: 11/801,518

(22) Filed: May 9, 2007

(51) Int. Cl. G06F 3/12

(52) U.S. Cl. 358/1.15

(57) ABSTRACT

A system and method for sending different portions of a document to different output destinations where different portions of a document can be processed differently. The notion of a printer or output device is expanded to include multiple destinations with rules that define what content will be sent to each of the destinations. In order to ease management of the system, an optional centralized management system to enable the distribution of rules to systems where the printers are defined is proposed. An enhancement to print driver software allows the additional rules-based multiple output device handling configuration and programming.

### TECHNICAL FIELD

Embodiments are generally related to image-processing systems and rendering devices, such as printers, photo-copy machines, scanners, fax machines and the like. Embodiments are also related to the field of multiple output devices for sending different portions of a document to different output device with rules-based sub-job device selection.

### BACKGROUND OF THE INVENTION

In automated manufacturing systems, there are a number of elements required for producing a product from a design. In the field of printing, the desired product is a publication, such as a book. In printing, the design is typically an electronic version of the publication, called a document. In order to get the publication, a user specifies the document, the resources to use, and how to use the resources. For example, one simple desktop printing task would require the user to specify the document and the resources would simply be the printer attached to the user's computer.

A slightly more complicated task would require the user to specify the document and a network printer, which is a printer the computer may reach via a computer network. In a complicated example, a user has a document that must be printed on an offset press. In this case, the resources can include the types of paper, ink, and the press itself. The process of producing the publication can include tasks such as preflight, imposition, watermarking, printing, and joining. In this more complicated case, the user can create a print job by combining the document and a specification of what tasks and materials are required to produce the desired document.

A method using a printing system comprising a controller programmed for rendering imposed documents given media cost considerations has been described in the art. The method includes steps of evaluating a print job, evaluating media loaded within printer, and determining media print options including cost. Additionally, embodiments enable user selection of printing options prior to selection of the printing system, rendering of the print job or selecting a printing option based on a user profile. The print job is then rendered.

In other art, print jobs are typically created as a combination of a document to be printed and the resources required for printing. A queue, or functionally similar construct, specifies the required resources and how they will be used. Users must be alerted to queue changes to avoid undesired results. Additionally, requiring an approval process such as voting can limit inappropriate queue changes. Included are elements for alerting users and voting on queue changes.

When authoring complex documents, different portions of the documents are sent to different output devices. For example, authors might be authoring a document such as a booklet with color covers and inserts that must ultimately be sent to both a color and a mono printer. Similarly authoring for use with background forms may require different portions of a job sent to different queues in the same device (on queue to RIP (Raster Image Processing) and save the background form and another queue to use the background form)). When a requirement of this sort exists on a document, this is handled via either manual submission of portions of the document to multiple destinations or submission to a processing system that will attempt to separate the different portions of the original document.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, an aspect of the present invention to provide for an improved image-processing systems and rendering devices, such as printers, photo-copy machines, scanners, fax machines and the like.

It is another aspect of the present invention to provide multiple output devices for sending different portions of a document to different output device with rules-based sub-job device selection.

The aforementioned aspects and other objectives and advantages can now be achieved as described herein. A system and method for sending different portions of a document to different output destinations where they will be processed differently is disclosed. The notion of a printer or output device is expanded to include multiple destinations with rules that define what content will be sent to each of the destinations. In order to ease management of the system, an optional centralized management system to enable the distribution of rules to systems where the printers are defined is also preselected. An enhancement to print driver software allows the additional rules-based multiple output device handling configuration and programming.

The invention brings all types of sub-job content segregation under a single, common interface and leverages more deterministic information (e.g. metadata vs. PDL properties) to define how a job should be routed. While some of this functionality may be available in current products (e.g. Color Splitting), this invention allows the document author to review and override otherwise automatic page assignments to different output devices. Distribution of rules for how sub-job content should be split between multiple output devices enables the central control afforded by centralized systems while avoiding the potential bottleneck of having all content go through a single system for routing.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a representative image-processing system which can be utilized for sending different portions of a document to different output devices with rules-based sub-job device selection, in accordance with a preferred embodiment;

FIG. 2 illustrates a high level flow chart of operations depicting logical operational steps for sending different portions of a document to different output devices with rules-based sub-job device selection, which can be implemented in accordance with a preferred embodiment;

FIG. 3 illustrates a graphical user interface display to view automatic printer and page selections for a document, in accordance with a preferred embodiment; and

FIG. 4 illustrates a graphical user interface display to change automatic printer and page selections for a document, in accordance with a preferred embodiment.

### DETAILED DESCRIPTION

The particular values and configurations discussed in these non-limiting examples can be varied and are cited merely to illustrate at least one embodiment and are not intended to limit the scope thereof.

It is important to note that, although the embodiments are described in the context of a fully functional data-processing system (e.g., a computer system), those skilled in the art will appreciate that the mechanisms of the embodiments are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

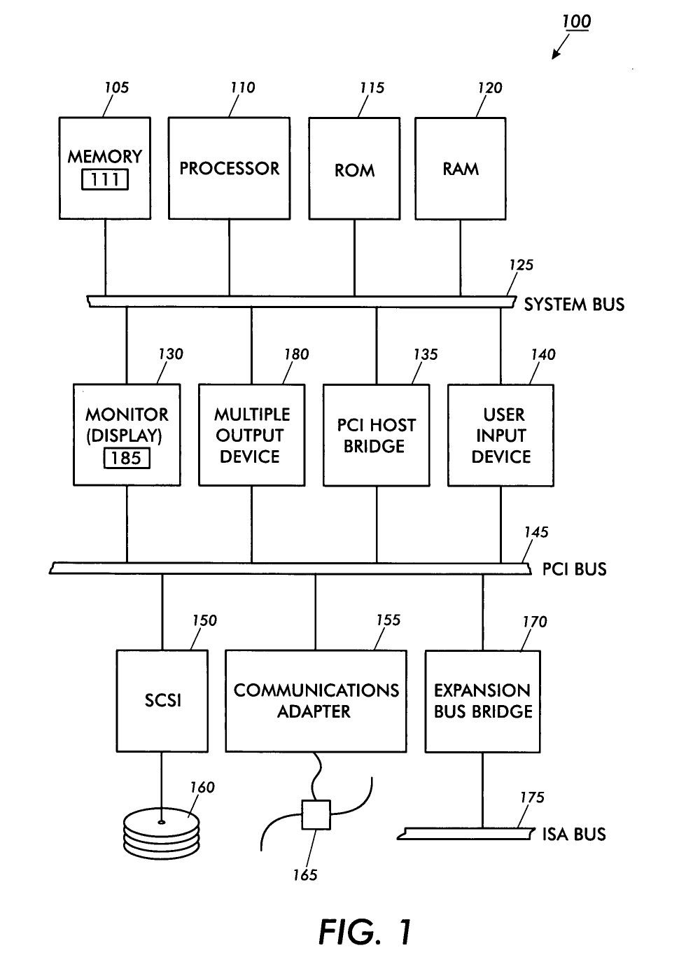

FIG. 1 illustrates a block diagram of a representative image-processing system 100 which can be utilized for sending different portions of a document to different output device with rules-based sub-job device selection, in accordance with a preferred embodiment. As shown in FIG. 1, a memory 105, a processor (CPU) 110, a Read-Only memory (ROM) 115, and a Random-Access Memory (RAM) 120 are generally connected to a system bus 125 of system 100. Memory 105 can be implemented as a ROM, RAM, a combination thereof, or simply a general memory unit. Module 111 can be stored within memory 105 and then retrieved and processed via processor 110 to perform a particular task. A user input device 140, such as a keyboard, mouse, or another pointing device, can be connected to PCI (Peripheral Component Interconnect) bus 145. A multiple output device 180, which can combine several core technologies, including image scanning, document printing, and fax signaling, into a single unit, can also be connected to PCI bus 145.

Data-processing system thus includes CPU 110, ROM 115, and RAM 120, which are also coupled to Peripheral Component Interconnect (PCI) local bus 145 of data-processing system 100 through PCI host-bridge 135. PCI Host Bridge 135 provides a low latency path through which processor 110 may directly access PCI devices mapped anywhere within bus memory and/or input/output (I/O) address spaces. PCI Host Bridge 135 also provides a high bandwidth path for allowing PCI devices to directly access RAM 120.

Also attached to PCI local bus 145 are communications adapter 155, small computer system interface (SCSI) 150, and expansion bus-bridge 170, communications adapter 155 is utilized for connecting data-processing system 100 to a network 165. SCSI 150 is utilized to control high-speed SCSI disk drive 160. Expansion bus-bridge 170, such as a PCI-to-ISA bus bridge, may be utilized for coupling ISA bus 175 to PCI local bus 145. Note that PCI local bus 145 can further be connected to a monitory 130, which functions as a display (e.g., a video monitor) for displaying data and information for a user and for interactively displaying a graphical user interface (GUI) 185.

Note that the term “GUI” generally refers to a type of environment that represents programs, files, options and so forth by means of graphically displayed icons, menus, and dialog boxes on a computer monitor screen. A user can interact with the GUI 185 to select and activate such options by pointing and clicking with a user input device such as, for example, a pointing device such as a mouse, and/or with a keyboard. A particular item can function in the same manner to the user in all applications because the GUI 185 provides standard software routines (e.g., module 111) to handle these elements and reports the user's actions.

The user would define a multi-output printer or output device 180 on system 100. The properties for a multi-output device 180 would include rules that are used for determining what job content gets sent to each output device. For example, a booklet multi-output printer would consist of two printers, one mono and one color. Each of these printers would be configured as they would normally be configured. However, the listing of printers in the multi-output printer configuration would also include the option to set rules and programming for that printer. The user could, for example, define the mono printer as the “default printer” and set an “interleave” rule for the color printer that would automatically send color pages to the color printer. This rule would also ensure that the extracted pages were “interleaved” in the output for the mono printer by adding page exception programming to the mono print job.

A manual multi-output printer would perhaps use authoring document metadata to route jobs to the proper output device. This would allow tags from a content management system to define how the pages in the document should be printed. This could serve a similar purpose as the Color Split option; however, it would be immune to misrouting because of color content (e.g. screen shots) that should be printed in black and white.

The system 100 may also be configured so that the multi-output printer and the associated rules are defined centrally. This would be analogous to how network printers are defined in a central directory. Once the content routing rules are established, the multi-output device 180 behaves like any other printer. When the user decides to output the job, the user simply selects to print and the system 100 transparently performs the configured evaluation, multiple PDL creation, proper programming and submission to multiple output device 180. Optionally, the user may choose to review results before submission. An interactive window allows the user to see what pages are being sent to what output device. The user reviews pages either on a per device basis or on a document basis. In either case, the user can be able to override the automatic device selections by selecting one or more pages and changing the desired output device. Once all pages are assigned to the desired output device, the user can print the job to the multiple output devices 180.

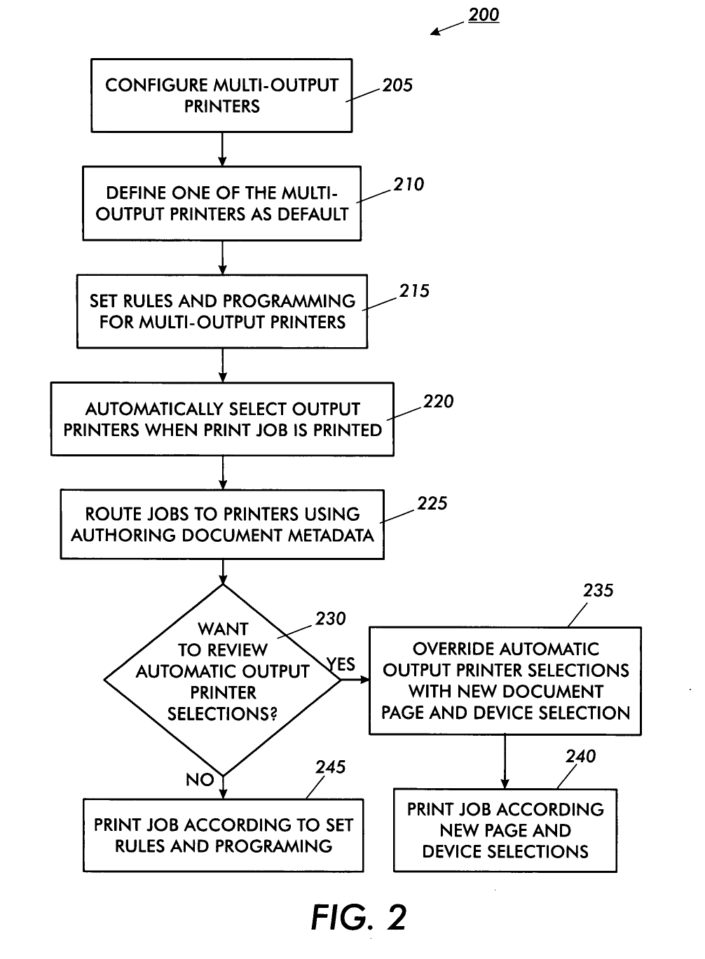

FIG. 2 illustrates a high level flow chart 200 of operations depicting logical operational steps for sending different portions of a document to different output device with rules-based sub-job device selection, which can be implemented in accordance with a preferred embodiment. Note that the process or method 200 described in FIG. 2 can be implemented in the context of a software module such as module 111 of system 100 depicted in FIG. 1. A multiple-output printer or output device 180 on system 100 depicted in FIG. 1 can be configured as said at block 205. As depicted at block 210, one of the multiple-output devices can be defined as a default. As indicated at block 215, rules and programs for the multiple-output device 180 on system 100 depicted in FIG. 1 can be set for sending different portion of a document to multiple-output devices. Each of the multiple-output devices 180 on system 100 depicted in FIG. 1 processes the document differently. The multiple-output devices 180 on system 100 depicted in FIG. 1 for each page in a job can be automatically selected when a print job is printed as depicted at block 220.

Pages can be routed to appropriate printers by using authoring document metadata as said at block 225. As depicted at block 230, the system 100 depicted in FIG. 1 check whether the user wants to override the automatic device selections. As indicated at block 235, if the user has chosen to review the automatic device selection, the user can override automatic device selection with new document page and device selection. Otherwise as said at block 245, user can print the document according to set rules and programs. Finally as shown at block 240, the user can print the document according to new page and device selection after overriding automatic device selection.

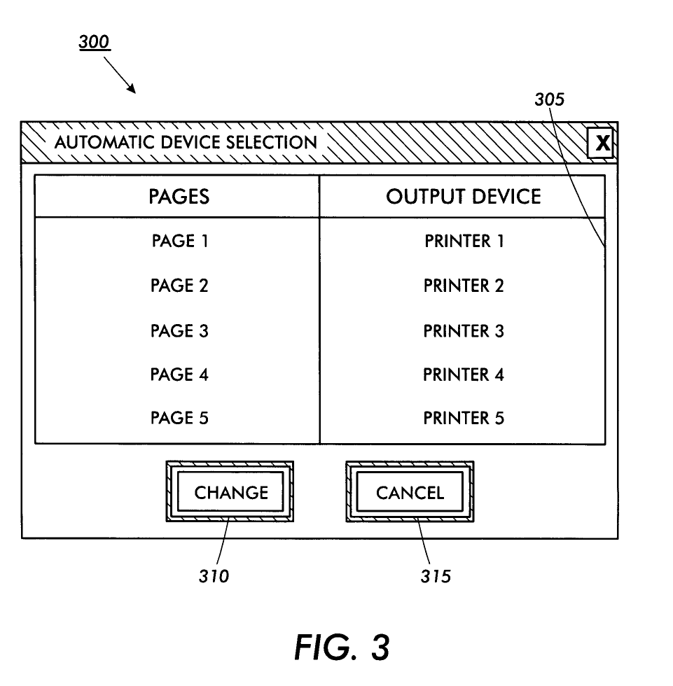

FIG. 3 illustrates a graphical user interface 300 to view automatic printer and page selections for a document, in accordance with a preferred embodiment. The block 305 shows the page and its corresponding automatic device selection by the system 100 depicted in FIG. 1, when a document is printed. The user can override the automatic device selection by clicking change a button as shown in block 310 or can use the automatic device selection for printing by clicking a cancel button 315.

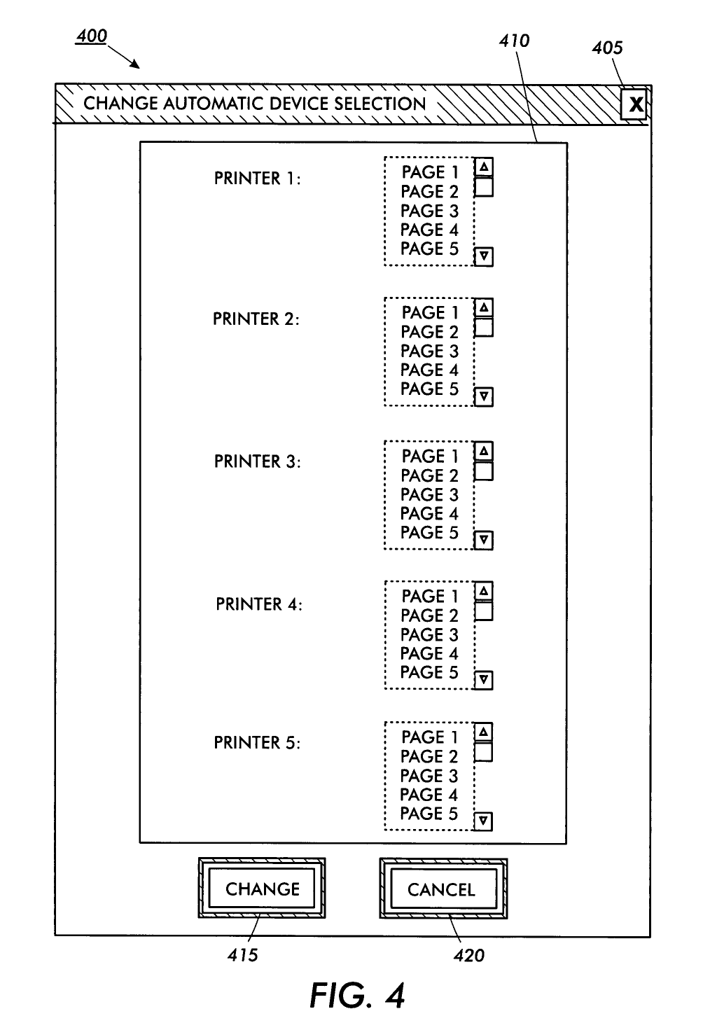

FIG. 4 illustrates a graphical user interface 400 to change automatic printer and page selections for a document, in accordance with a preferred embodiment. The block 405 allows the user to override the automatic device selection. The user can review the pages either on a per device basis or on a document basis. In either case, the user would be able to override the automatic device selections by selecting one or more pages, changing the desired output device and clicking change button as shown in block 415. The user can cancel the user selection by clicking cancel button 420. Once all pages are assigned to the desired output device, the user can print the job to the multiple output devices 180 on system 100 depicted in FIG. 1.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer implemented method for sending different portions of a document to output devices with rules-based sub-job device selection, comprising:
configuring output devices;
defining at least one of said output devices as a default;
setting rules and programs for said output devices;
automatically selecting said output devices based on said rules and programs; and
routing a document to at least one output device using authoring document metadata.

2. The method of claim 1 further comprises printing said document based on said rules and programs.

3. The method of claim 1 further comprises:
overriding automatic selections of said output devices with a new document page and device selection; and
printing said document based on said rules and programs.

4. The method of claim 1 wherein said plurality of rules and programs determines how print job content gets divided among said output devices.

5. The method of claim 1 wherein said output devices and said rules and programs associated with said output devices can be defined centrally by a server.

6. A method for configuring a system including output devices with rules-based sub-job device selection for processing different portions of a document, comprising:
configuring output devices with rules and programs enabling rules-based sub-job device selection;
defining at least one of said output devices as a default;
enabling automatic selection of said output devices based on said rules and programs; and
routing a document to at least one output device using authoring document metadata.

7. The method of claim 6 further comprises printing said document based on said rules and programs.

8. The method of claim 6 further comprises:
overriding automatic selections of said output devices with a new document page and device selection; and
printing said document based on said rules and programs.

9. The method of claim 6 wherein said plurality of rules and programs determines how print job content gets divided among said output devices.

10. The method of claim 6 wherein said output devices and associated said rules and programs can be defined centrally.

11. A computer implemented system for sending different portions of a document to a plurality of output devices with rules-based sub-job device selection, comprising:
a data-processing apparatus;
a module executed by said data-processing apparatus, said module and said data-processing apparatus being operable in combination with one another to:
configure said plurality of output devices;
define at least one said output devices as default; and
set a plurality of rules and programs for said output devices;
wherein said system enables automatic selection of said output devices based on said plurality of rules and programs.

12. The system of claim 11 wherein said module and said data-processing apparatus being operable in combination with one another for sending different portions of a document to a output devices with rules-based sub-job device selection, is further enabled to print a document based on said rules and programs.

13. The system of claim 11 wherein said module and said data-processing apparatus being operable in combination with one another for sending different portions of a document to a output devices with rules-based sub-job device selection, is further enabled to print a document based on metadata.

14. The system of claim 11 wherein said module and said data-processing apparatus being operable in combination with one another for sending different portions of a document to a output devices with rules-based sub-job device selection, further comprises:
overriding automatic selections of said output devices with a new document page and device selection; and
printing said document based on said rules and programs.

15. The system of claim 11 further enabled so printing of a document is based on said rules and programs.

16. The system of claim 11 wherein said system is adapted to enable:
overriding automatic selections of said output devices with a new document page and device selection; and
printing said document based on said rules and programs.

17. The system of claim 11 wherein said plurality of rules and programs determines how print job content gets divided among said output devices.

18. The system of claim 11 wherein said output devices and associated said rules and programs are defined centrally at a server.
